(19) United States
(12) Patent Application Publication
(10) Pub. No.: US 2018/0341366 A1
(43) Pub. Date: Nov. 29, 2018

(54) NON-EDGE PROJECTION AND INTEGRATED TOUCH ELECTRONIC WHITEBOARD

(71) Applicant: Suzhou Maxpad Technologies Co., Ltd, Jiangsu Province (CN)

(72) Inventors: Ming-Tang TSAI, Taipei City (TW); Huaming WANG, Jiangsu Province (CN)

(21) Appl. No.: 15/868,039

(22) Filed: Jan. 11, 2018

(30) Foreign Application Priority Data
May 26, 2017 (CN) 201710385877.0
Jun. 6, 2017 (CN) 201710420098.X

(51) Int. Cl. G06F 3/042; G06F 3/041; G09G 5/00

(52) U.S. Cl. CPC G06F 3/0425; G06F 3/0416; G09G 2354/00; G09G 2370/12; G09G 5/006

(57) ABSTRACT

The present utility model discloses a non-edge projection and integrated touch electronic whiteboard, comprising: an electronic whiteboard, infrared cameras, a touch mainboard, and a computer. A frame is disposed around the electronic whiteboard. An inner side wall of the frame is provided with an optical reflection strip. The computer separates the electronic whiteboard into a left writing area, a right writing area, and an intermediate touch area. Two infrared cameras are disposed on a same end of an upper frame and a lower frame of the intermediate touch area. The infrared cameras face the intermediate touch area.

### FIELD OF THE UTILITY MODEL

The present utility model relates to an electronic whiteboard, and in particular, to a non-edge projection and integrated touch electronic whiteboard.

### BACKGROUND OF THE UTILITY MODEL

The electronic whiteboard is widely used in conference rooms, classrooms, and the like. Due to the limitation by the projection range and impact from the electronic whiteboard structure, application in the education field has structural constraints. In the past, a common means in the market is to additionally arrange a greenboard around the electronic whiteboard for writing. Such a manner leads to a miscellaneous structure, making it inconvenient to use.

To overcome the foregoing problem, currently, a writing area and touch control of an electronic whiteboard are integrated on a panel, so that a user may write on the electronic whiteboard, and look through materials in a computer by means of touch control. The electronic whiteboard is used in teaching and conferencing, and becomes a new-type multi-media device. Such a structure is simple, convenient to use, and improves the product appearance. Currently, on the touch area and writing area integrated electronic whiteboard, the touch area is arranged on a side of the writing area. Current teaching materials are most in the PPT form, the writing area is rarely used, and even some teachers/conference organizers do not use the writing area during teaching and communication. If the touch area is arranged on a side of the electronic whiteboard, students/attendees sitting in front of and on the other side of the electronic whiteboard cannot clearly see teaching materials in the touch area.

### SUMMARY OF THE UTILITY MODEL

To overcome the foregoing disadvantage, the objective of the present utility model is to provide a non-edge projection and integrated touch electronic whiteboard, so that students/attendees in the front row of the electronic whiteboard can clearly see teaching materials in a touch area on the electronic whiteboard.

To achieve the foregoing objective, a technical solution used in the present utility model is a non-edge projection and integrated touch electronic whiteboard, comprising: an electronic whiteboard, infrared cameras, a touch mainboard, and a computer. A frame is disposed around the electronic whiteboard. An inner side wall of the frame is provided with an optical reflection strip. The electronic whiteboard is connected to the computer. The infrared cameras are connected to the computer by using the touch mainboard. The computer separates the electronic whiteboard into a left writing area, a right writing area, and an intermediate touch area. Two infrared cameras are provided. The two infrared cameras are disposed on a same end of an upper frame and a lower frame of the intermediate touch area. The infrared cameras face the intermediate touch area.

Beneficial effects of the non-edge projection and integrated touch electronic whiteboard in the present utility model are as follows: The intermediate touch area is arranged in the middle of the electronic whiteboard. In a use process, a probability of using the intermediate touch area is far greater than a probability of using the left and right writing areas. In this solution, the intermediate touch area is arranged in the middle of the electronic whiteboard, so that students/attendees in front of the electronic whiteboard can clearly see teaching materials in the touch area of the electronic whiteboard, resolving a problem that because the touch area is arranged on a side of the electronic whiteboard, students/attendees sitting in front of and on the other side of the electronic whiteboard are affected in see teaching materials. In addition, the writing areas are located on two ends of the electronic whiteboard, on which writing can be performed at the same time.

Preferably, the computer is built in the electronic whiteboard. As built in the electronic whiteboard body, the computer host is not easily damaged in transport and installation processes.

Preferably, an ultra short-focus projector is further disposed above the intermediate touch area, and the ultra short-focus projector is connected to the computer by using an HDMI cable. Because the ultra short-focus projector is disposed above the intermediate touch area of the electronic whiteboard body, a problem of a projection failure caused as an object blocks projected light is resolved.

Preferably, the HDMI cable and the computer are connected by using an HDMI interface board, and the HDMI interface board is built in the electronic whiteboard. As built in the electronic whiteboard body, the HDMI interface board is not easily damaged in transport and installation processes.

Preferably, the intermediate touch area is connected to the touch mainboard, and the touch mainboard drives touch control of the intermediate touch area to be enabled or disabled. The intermediate touch area of the electronic whiteboard may be disabled by using a switch, to write on the entire whiteboard by using a whiteboard marker.

### BRIEF DESCRIPTION OF THE DRAWINGS

FIG. 1 is a main view of Embodiment 1; and

FIG. 2 is a main view of Embodiment 2.

In the Figures: 1: Frame; 2: Optical reflection strip; 3: Electronic whiteboard; 31: Left writing area; 32: Right writing area; 33: Intermediate touch area; 4: Touch mainboard; 5: Infrared camera; 6: Ultra short-focus projector; and 7: Computer.

### DETAILED DESCRIPTION OF THE UTILITY MODEL

To enable persons skilled in the art to more easily understand the advantages and features of the present utility model, the following provides a detailed description with reference to the accompanying drawings by using preferred embodiments of the present utility model, to define the protection scope of the present utility model clearer.

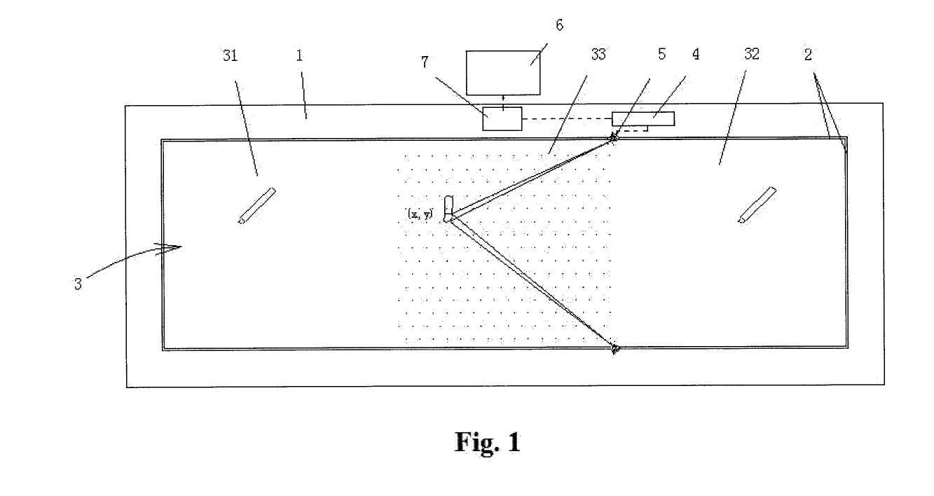

Referring to FIGS. 1, a non-edge projection and integrated touch electronic whiteboard in Embodiment 1 comprises an electronic whiteboard 3, infrared cameras 5, a touch mainboard 4, a computer 7, and an ultra short-focus projector 6. A frame 1 is disposed around the electronic whiteboard 3. An inner side wall of the frame 1 is provided with an optical reflection strip 2. The electronic whiteboard 3 is connected to the computer 7. The computer 7 is built in the electronic whiteboard 3. The infrared cameras 5 are connected to the computer 7 by using the touch mainboard 4. The ultra short-focus projector 6 is disposed above an intermediate touch area 33. The ultra short-focus projector 6 is connected to the computer 7 by using an HDMI cable. With the HDMI cable, electronic information on the electronic whiteboard may be output for man-machine operations. The HDMI cable and the computer 7 are connected by using an HDMI interface board. The HDMI interface board is built in the electronic whiteboard 3. A switch is connected to the computer 7. The computer 7 separates the electronic whiteboard 3 into a left writing area 31, a right writing area 32, and the intermediate touch area 33. The intermediate touch area 33 is limited by touch program coordinates, and located at a central position or a center-left or center-right position of the electronic whiteboard 3. The infrared cameras 5 may project to the left and right, and implement touch control of the intermediate area of any size. The intermediate touch area 33 is arranged in an infrared projection area. The infrared projection area is an area formed by the optical reflection strip and projection directions of the infrared cameras 5. When the infrared cameras 5 project to the left, the infrared projection area covers the left writing area 31 and the intermediate touch area 33; when the infrared cameras 5 project to the right, the infrared projection area covers the right writing area 32 and the intermediate touch area 33. The intermediate touch area 33 may be adjusted as required by using a program. Two infrared cameras 5 are provided. The two infrared cameras 5 are disposed on a same end of an upper frame and a lower frame of the intermediate touch area 33. In this embodiment, the two infrared cameras 5 are disposed on a right end of the upper frame and the lower frame. The infrared cameras 5 face the intermediate touch area 33. The intermediate touch area 33 is used to achieve a touch control function of the whiteboard. Writing can be performed in the left writing area 31 and the right writing area 32 at the same time by using whiteboard markers. The intermediate touch area 33 is connected to the touch mainboard 4. The touch mainboard 4 drives touch control of the intermediate touch area 33 to be enabled or disabled. Alternatively, the touch control function of the whiteboard may be disabled by using the switch, to write on the entire whiteboard by using a whiteboard marker.

An infrared touch control principle belongs to the prior art. Each infrared camera has an LED light source (not shown in the figure) inside. The LED light source emits infrared light to the optical reflection strip 2 opposite, and the optical reflection strip 2 reflects the infrared light emitted by the LED to the infrared camera 5. If there is no object operating in the intermediate touch area 33 of the electronic whiteboard, the infrared camera 5 receives the reflected light of the optical reflection strip 2. Once there is an object operating in the intermediate touch area 33 of the electronic whiteboard, the light of the LED light source of the infrared camera 5 cannot reach the optical reflection strip 2, and the infrared camera 5 cannot detect the reflected light. According to the principle, the two infrared cameras 5 transmit detected signals to the touch mainboard 4. The touch mainboard 4 is connected to the computer 7. The touch mainboard 4 calculates, by using the computer 7, data of a touch point on the optical reflection strip 2, to obtain touch coordinates (X, Y).

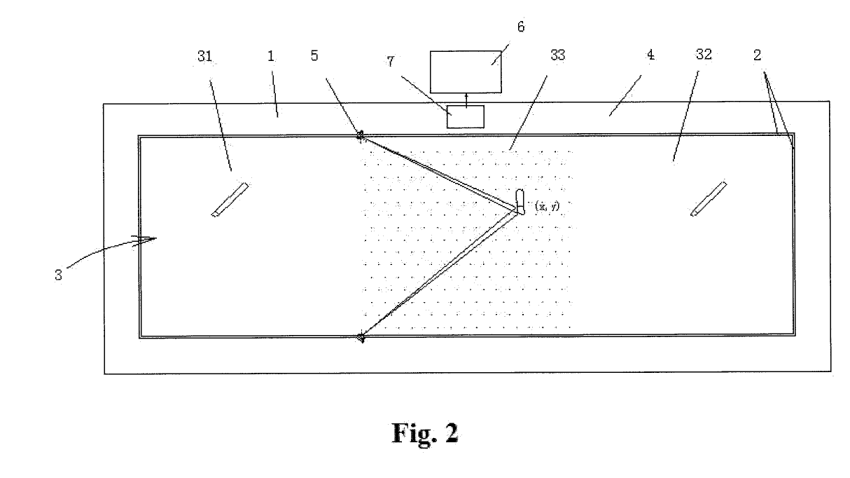

In Embodiment 2, as shown in FIG. 2, different from Embodiment 1, the two infrared cameras 5 are disposed on a left end of the upper frame and the lower frame of the intermediate touch area 33.

The aforementioned implementations are merely to explain the technical ideas and features of the present utility model, intended to help persons skilled in the art to understand and implement the present utility model, and not intended to limit the protection scope of the present utility model. Various equivalent variations or modifications made without departing from the spirit and essence of the present utility model shall fall within the protection scope of the present utility model.

1. A non-edge projection and integrated touch electronic whiteboard, comprising: an electronic whiteboard (3), infrared cameras (5), a touch mainboard (4), and a computer (7), wherein a frame (1) is disposed around the electronic whiteboard (3), an inner side wall of the frame (1) is provided with an optical reflection strip (2), the electronic whiteboard (3) is connected to the computer (7), and the infrared cameras (5) are connected to the computer (7) by using the touch mainboard (4), wherein: the computer (7) separates the electronic whiteboard (3) into a left writing area (31), a right writing area (32), and an intermediate touch area (33), two infrared cameras (5) are provided, the two infrared cameras (5) are disposed on a same end of an upper frame and a lower frame of the intermediate touch area (33), and the infrared cameras (5) face the intermediate touch area (33).

2. The non-edge projection and integrated touch electronic whiteboard according to claim 1, wherein: the computer (7) is built in the electronic whiteboard (3).

3. The non-edge projection and integrated touch electronic whiteboard according to claim 1, wherein: an ultra short-focus projector (6) is further disposed above the intermediate touch area (33), and the ultra short-focus projector (6) is connected to the computer (7) by using an HDMI cable.

4. The non-edge projection and integrated touch electronic whiteboard according to claim 3, wherein: the HDMI cable and the computer (7) are connected by using an HDMI interface board, and the HDMI interface board is built in the electronic whiteboard (3).

5. The non-edge projection and integrated touch electronic whiteboard according to claim 1, wherein: the intermediate touch area (33) is connected to the touch mainboard (4), and the touch mainboard (4) drives touch control of the intermediate touch area (33) to be enabled or disabled.

6. The non-edge projection and integrated touch electronic whiteboard according to claim 1, wherein: the intermediate touch area (33) is located at a central position or a center-left or center-right position of the electronic whiteboard (3).
